(19) United States
(12) Patent Application Publication
(10) Pub. No.: US 2013/0211937 A1
(43) Pub. Date: Aug. 15, 2013

(54) USING CREDIT CARD/BANK RAILS TO ACCESS A USER'S ACCOUNT AT A POS

(71) Applicants: Marc Elbirt, Plesanton, CA (US); David Eaton, San Jose, CA (US)

(72) Inventors: Marc Elbirt, Plesanton, CA (US); David Eaton, San Jose, CA (US)

(21) Appl. No.: 13/763,476

(22) Filed: Feb. 8, 2013

Related U.S. Application Data
(60) Provisional application No. 61/596,867, filed on Feb. 9, 2012.

(51) Int. Cl. G06Q 20/20

(52) U.S. Cl. CPC G06Q 20/204
USPC 705/17; 705/21

(57) ABSTRACT

A payment provider card can be used on any credit card or bank network in order to access the user's payment provider account at the POS of non-payment provider integrated merchants. The consumer may swipe or have the card read through NFC or other means, at the POS, where the information contained in the card is communicated to the payment provider through a credit card or bank card network or rails that is already part of the merchant payment network.

### CROSS REFERENCE TO RELATED APPLICATION

This application claims priority to U.S. Provisional Pat. Appl. Serial No. 61/596,867, filed Feb. 9, 2012, which is incorporated by reference in its entirety.

### BACKGROUND

1. Field of the Invention

The present invention generally relates financial transactions, and in particular, to payments at a point of sale (POS).

2. Related Art

Payment providers, such as PayPal, Inc. of San Jose, Calif., offer users the ability to make purchases online and offline (e.g., at a physical store or POS). For offline purchases, the user typically has to enter or provide authenticating information, such as a user identifier and PIN/password through a merchant PIN pad. The merchant also has to be integrated with the payment provider to accept payments through the payment provider. This can be costly and time-consuming for merchants, and as a result, some merchants may forego offering the payment provider as a payment option. This can be detrimental to the merchant and the consumer, as the merchant may lose potential sales if the consumer is only able to pay through a payment provider account and the consumer may lose a desired purchase because of the inability to pay with another funding source.

Therefore, a need exists to allow consumers to make payments with a payment provider account at POS locations not integrated with the payment provider.

### BRIEF DESCRIPTION OF THE DRAWINGS

FIG. 1 is a flowchart showing a process for performing a payment transaction using a hybrid card according to one embodiment;

FIG. 2 is a block diagram of a networked system suitable for implementing the process of FIG. 1 according to an embodiment; and

FIG. 3 is a block diagram of a computer system suitable for implementing one or more components in FIG. 2 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment, a payment provider card can be used on any credit card or bank network in order to access the user's payment provider account at the POS of non-payment provider integrated merchants. The consumer may swipe or have the card read through NFC or other means, at the POS, where the information contained in the card is communicated to the payment provider through a credit card or bank card network or rails that is already part of the merchant payment network.

In one embodiment, a user has a readable card that includes both information about a user account with a payment provider, such as PayPal, Inc. of San Jose, Calif., and information about a credit card or bank card. The card may be NFC enabled (e.g., has an embedded NFC chip), have a QR or other code attached, and/or have a mag stripe. The information contained on or in the card may include an account number and name of the user for the payment provider account and sufficient information about the credit/bank card to allow card information to be communicated along the credit/bank card rails. The rails may already by integrated with the merchant POS or network.

Once the card is read at the POS, the payment provider account information may be communicated to the payment provider on the credit/bank card rails. The payment provider may receive the information directly from the rails. In another embodiment, the payment provider receives the information from the credit/bank card issuer. The information may be encrypted for security so that the user account information with the payment provider is not exposed to the credit/bank card issuer.

After receiving the information, the payment provider may locate the user account based on the received information. If a valid account exists, the payment provider may request authenticating information from the user, again through the credit/bank card rails. For example, the user may be asked to enter a PIN or password on a merchant device, such as a PIN pad. The PIN is then communicated back to the payment provider along the credit/bank card rails. The PIN may he encrypted at the different layers of the PIN pad before transmission to the payment provider for security purposes.

The payment provider may then process a payment request from the merchant, where the merchant may transmit transaction details, including the total amount requested, merchant identifier(s), and/or item description(s).

The payment provider may then notify the merchant and/or the user of an approved or denied payment request. If approved, the transaction may be completed. As a result, a user is able to make a payment at a merchant PUS using a payment provider account even though the merchant is not integrated with the payment provider. This is possible because communication is through existing credit/bank card rails.

For merchants integrated with the payment provider, the same card can be used to process the payment request through the payment provider network or rails, even though the card also has a credit/bank card identifier. In one embodiment, the POS reads the card and determines whether the payment request can be communicated through the payment provider network or rails. If so, the payment request is sent through the payment provider network or rails. Some indicator, such as the BIN range or an unused bit, within the card's track data could be used to tell the POS system to route through the payment provider network. This allows the payment provider to provide services/features that may not be available from the bank/credit card network.

As a result, both merchants and consumers can take advantage of an additional funding source provided by a payment provider, even when the merchant is not integrated with the payment provider.

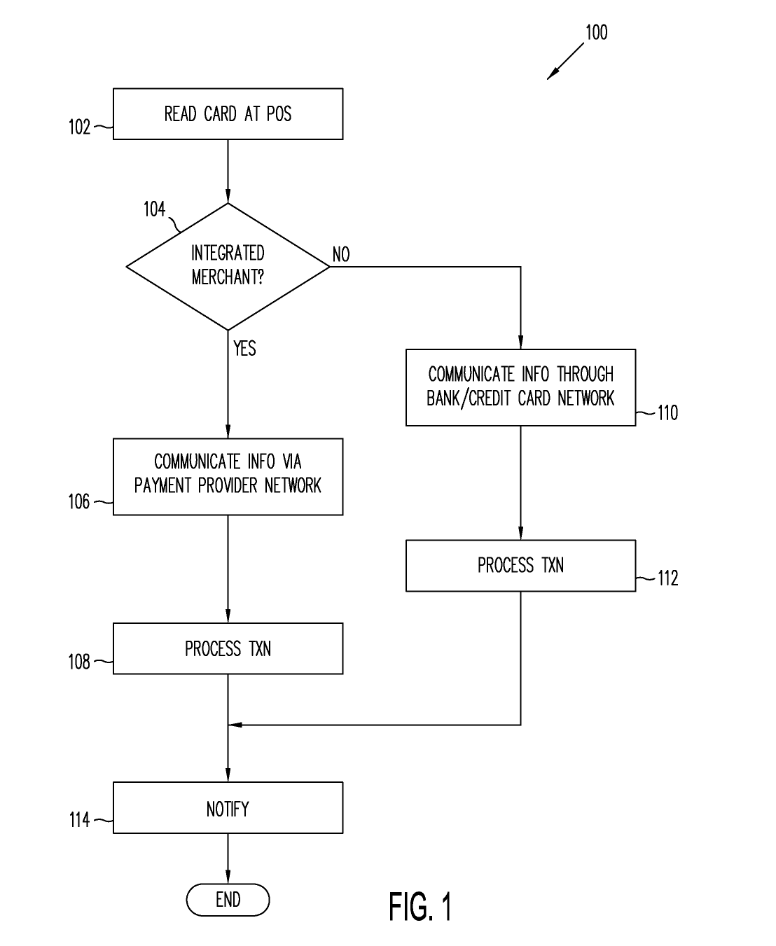

FIG. 1 is a flowchart showing a process 100 for performing a payment transaction using a hybrid card according to one embodiment. At step 102, the user's card, which may be referred to herein as a hybrid card, is read at a merchant point of sale (POS). The hybrid card may be a plastic card containing information identifying a user account with a third party payment provider, such as PayPal, Inc. of San Jose, Calif., and information identifying a user account with a bank or credit card company. Information may include one or more of an account number, an expiration date, a security code, a name, a phone number, and other account/user identifiers. The information may be contained in a magnetic stripe (or mag stripe or strip), an NFC chip, QR code, or other information storage means that can be read out from the card. The card may take different forms, including a biometric card without a visible card number in which a user's fingerprint enables a mag stripe to be read, a hidden card number in which a user PIN enables the card mag stripe or the PIN shows the full or partial card number, a multi-account card where the user may enable a mag stripe for a desired funding source (e.g., credit or debit), and a card with no account number visible (card information contained in a mag strip, NFC chip, QR code, etc.).

The card may be read by having the card swiped through a mag stripe reader at the POS, scanned by a barcode/QR code reader, or placed in front of an NFC reader. Other ways to read the card may also be suitable depending on how the card information is stored. The card may be read prior to, during, or after the checkout process.

After the card is read, a determination is made, at step 104, whether the merchant is integrated with the payment provider. The card may contain information that tells the POS device is a payment provider card or a hybrid card. Once determined that the card is a hybrid card, the POS device determines whether the merchant associated with the POS device is integrated with the payment provider, e.g., the merchant system has been configured to accept and process payments through the payment provider through a network or rails of or supported by the payment provider. For example, the information contained in the card indicating that the card is a hybrid card (i.e., enables payment through the payment provider) may be recognized only if the merchant is integrated with the payment provider. Integrated merchants may have at least two rails or networks with payment providers, one with banks or credit cards and the other with the payment provider. Non-integrated merchants would not have the payment provider network or rails available for use.

If the merchant is integrated with the payment provider, transaction information is communicated via the payment provider network or rails, at step 106. For example, the POS device may electronically transmit the user's payment account number (or other user/account identifier), along with a payment or purchase request, to the payment provider through an API call or other communication. The payment request may include details of the transaction, such as a merchant identifier, a merchant account number with the payment provider, a merchant account number with a bank, total purchase amount, item descriptions, item costs, item identifiers, etc.

Once received, the transaction may be processed, at step 108, by the payment provider. Using the payment provider rails or network, the payment provider may be able to offer specific features available through the payment provider. In other words, a typical processing with the payment provider occurs, such as account management, use of various incentives available through the user's wallet or obtained by the payment provider, suggestions for best mix of funding sources, receipt handling, etc.

However, even if the merchant is not integrated with the payment provider, as determined at step 104, the user may still use the payment provider to process the purchase or transaction. In that case, transaction information is communicated through a bank or credit card network or rails at step 110. The hybrid card has information that enables the POS device to communicate information from the card and/or transaction via bank/credit card network or rails to the payment provider, even though the transaction will be processed by the payment provider as opposed to the bank or credit card company. The same or similar information as described earlier may be communicated, such as an account identifier of the user with the payment provider and transaction information, such as a total amount of purchase, merchant identifier, merchant account, itemized descriptions and totals, etc.

The transaction is then processed at step 112. Because the transaction is processed through a non-payment provider network or rails, certain advantages and features of the payment provider may not be available to the user. However, the transaction may still be processed by the payment provider using the user's account with the payment provider. For example, the payment provider may debit the user's payment provider account for the payment and credit a merchant account accordingly. Thus, the user can still fund the purchase through the user's payment provider account, even though the merchant is not integrated with the payment provider.

Once the transaction is processed, either through the bank/credit or payment provider rails/network, the payment provider may send a notification, at step 114. The notification may be to the user on a user device and/or to the merchant on a merchant device. For example, the user may receive a notification on a smart phone or computing tablet that the payment was successful, along with details of the transaction, such as amount debited from the user account. The merchant may receive a notification, with a transaction identifier, that the payment was approved, which may allow the merchant to release the purchase to the user.

Note that one or more of the steps described herein may be omitted, combined, and/or performed in a different order as desired. A common step in one embodiment shares the same or similar features described with the corresponding step in the other embodiment.

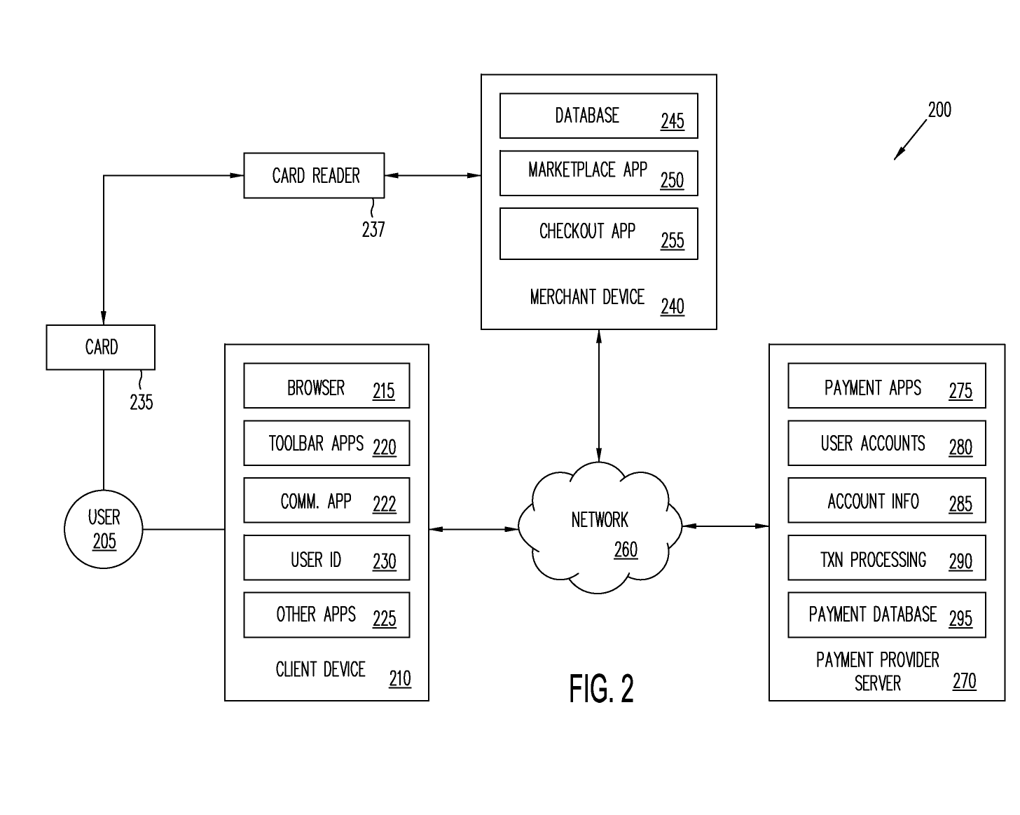

FIG. 2 is a block diagram of a networked system 200 configured to handle a financial transaction between a payment recipient (e.g., merchant) and a payment sender (e.g., user or consumer) at a POS, such as described above, in accordance with an embodiment of the invention. System 200 includes a user device 210, a merchant server 240, and a payment provider server 270 in communication over a network 260. Payment provider server 270 may be maintained by a payment provider, such as PayPal, Inc. of San Jose, Calif. A user 205, such as the sender or consumer, is associated with user device 210, where the user performs a payment transaction with merchant server 240 using payment provider server 270.

User device 210, merchant server 240, and payment provider server 270 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 200, and/or accessible over network 260.

Network 260 may be implemented as a single network or a combination of multiple networks. For example, in various embodiments, network 260 may include the Internet or one or more intranets, landline networks, wireless networks, and/or other appropriate types of networks. Network 260 may include a sub-network or rails for a credit card or bank company or a sub-network or rails for the payment provider. How information is communicated through the network may be determined by whether the merchant is integrated with the payment provider and whether a payment instrument used by the user enables communication with either network/rail, as discussed herein.

User device 210 may be implemented using any appropriate hardware and software configured for wired and/or wireless communication over network 260. For example, in one embodiment, the user device may be implemented as a personal computer (PC), a smart phone, personal digital assistant (FDA), laptop computer, and/or other types of computing devices capable of transmitting and/or receiving data, such as an iPad™ from Apple™.

User device 210 may include one or more browser applications 215 which may be used, for example, to provide a convenient interface to permit user 205 to browse information available over network 260. For example, in one embodiment, browser application 215 may be implemented as a web browser configured to view information available over the Internet. User device 210 may also include one or more toolbar applications 220 which may be used, for example, to provide client-side processing for performing desired tasks in response to operations selected by user 205. In one embodiment, toolbar application 220 may display a user interface in connection with browser application 215 as further described herein.

User device 210 may further include other applications 225 as may be desired in particular embodiments to provide desired features to user device 210. For example, other applications 225 may include security applications for implementing client-side security features, programmatic client applications for interfacing with appropriate application programming interfaces (APIs) over network 260, or other types of applications. Applications 225 may also include email, texting, voice and IM applications that allow user 205 to send and receive emails, calls, and texts through network 260, as well as applications that enable the user to communicate, place orders, and make payments through the payment provider as discussed above. User device 210 includes one or more user identifiers 230 which may be implemented, for example, as operating system registry entries, cookies associated with browser application 215, identifiers associated with hardware of user device 210, or other appropriate identifiers, such as used for payment/user/device authentication. In one embodiment, user identifier 230 may be used by a payment service provider to associate user 205 with a particular account maintained by the payment provider as further described herein. A communications application 222, with associated interfaces, enables user device 210 to communicate within system 200.

Merchant server 240 may be in communication with a PIN pad and/or a cash register for entry and transmission of the user's payment (or hybrid) card, as discussed above, both of which are not shown here. Merchant server 240 may be maintained, for example, by a merchant or seller offering various products and/or services in exchange for payment to be received over network 260. Generally, merchant server 240 may be maintained by anyone or any entity that receives money, which includes charities as well as retailers and restaurants. Merchant server 240 includes a database 245 identifying available products and/or services (e.g., collectively referred to as items) which may be made available for viewing and purchase by user 205, including receipts associated with identifiers, such as barcodes. Accordingly, merchant server 240 also includes a marketplace application 250 which may be configured to serve information over network 260 to browser 215 of user device 210. In one embodiment, user 205 may interact with marketplace application 250 through browser applications over network 260 in order to view various products, food items, or services identified in database 245.

Merchant server 240 also includes a checkout application 255 which may be configured to facilitate the purchase by user 205 of goods or services identified by marketplace application 250. Checkout application 255 may be configured to accept payment information from or on behalf of user 205 through payment service provider server 270 over network 260. For example, checkout application 255 may receive and process a payment confirmation from payment service provider server 270, as well as transmit transaction information to the payment provider and receive information from the payment provider. Checkout application 255 may also be configured to accept one or more different funding sources for payment, as well as create an invoice or receipt of the transaction.

Payment provider server 270 may be maintained, for example, by an online payment service provider which may provide payment between user 205 and the operator of merchant server 240. In this regard, payment provider server 270 includes one or more payment applications 275 which may be configured to interact with user device 210 and/or merchant server 240 over network 260 to facilitate the purchase of goods or services by user 205 of user device 210 at a merchant POS or site as discussed above.

Payment provider server 270 also maintains a plurality of user accounts 280, each of which may include account information 285 associated with individual users. For example, account information 285 may include private financial information of users of devices such as account numbers, passwords, device identifiers, user names, phone numbers, credit card infatuation, bank information, PINs/passwords, coupons, discounts, incentives, loyalty points, value items, or other financial information which may be used to facilitate online transactions by user 205. Merchant details may also be stored within account information 285 or another part of payment provider server 270. Advantageously, payment application 275 may be configured to interact with merchant server 240 on behalf of user 205 during a transaction with checkout application 255 to track and manage purchases made by users and which funding sources are used.

A transaction processing application 290, which may be part of payment application 275 or separate, may be configured to receive information from a user device and/or merchant server 240 for processing and storage in a payment database 295. Transaction processing application 290 may include one or more applications to process information from user 205 for processing an order and payment at a merchant POS as described herein. As such, transaction processing application 290 may store details of an order associated with transaction between a merchant and user. Payment application 275 may be further configured to determine the existence of and to manage accounts for user 205, as well as create new accounts if necessary.

Payment database 295 may store transaction details from completed transactions, including authorization details and/or details of the transaction. Such information may also be stored in a third party database accessible by the payment provider and/or the merchant.

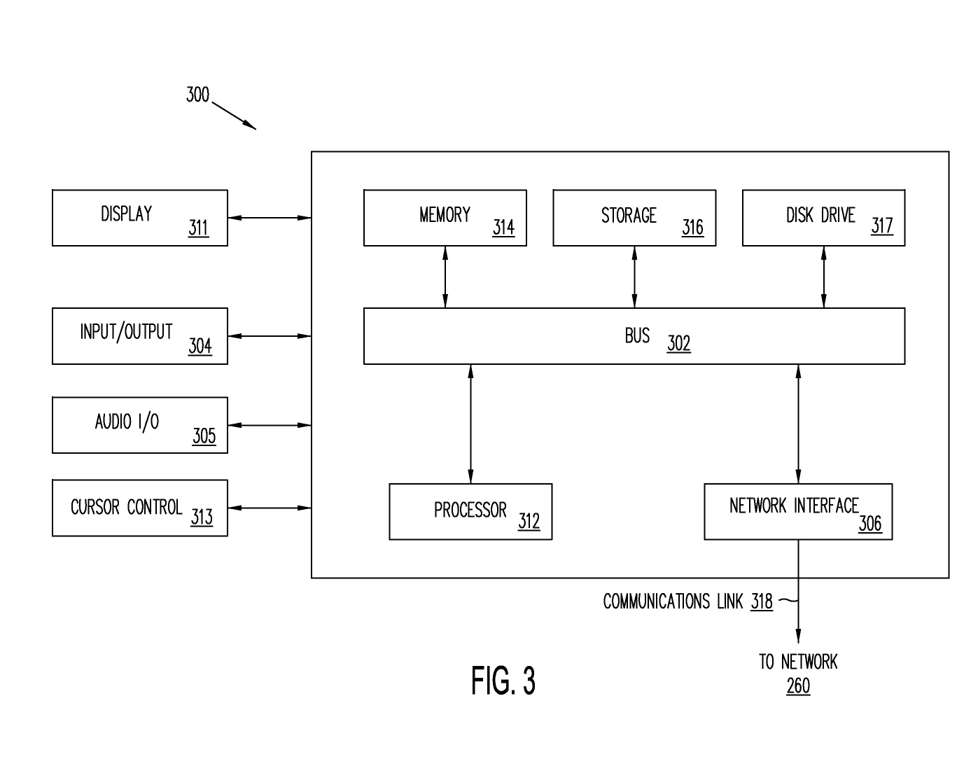

FIG. 3 is a block diagram of a computer system 300 suitable for implementing one or more embodiments of the present disclosure. In various implementations, the user device may comprise a personal computing device (e.g., a personal computer, laptop, smart phone, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 300 in a manner as follows.

Computer system 300 includes a bus 302 or other communication mechanism for communicating information data, signals, and information between various components of computer system 300. Components include an input/output (I/O) component 304 that processes a user action, such as selecting keys from a keypad/keyboard, selecting one or more buttons or links, etc., and sends a corresponding signal to bus 302. I/O component 304 may also include an output component, such as a display 311 and a cursor control 313 (such as a keyboard, keypad, mouse, etc.). I/O component 304 may include a card reader, such as an NFC reader, a mag stripe reader, or the like for reading a user hybrid card. An optional audio input/output component 305 may also be included to allow a user to use voice for inputting information by converting audio signals. Audio I/O component 305 may allow the user to hear audio. A transceiver or network interface 306 transmits and receives signals between computer system 300 and other devices, such as another user device, a merchant server, or a payment provider server via network 360. In one embodiment, the transmission is wireless, although other transmission mediums and methods may also be suitable. A processor 312, which can be a micro-controller, digital signal processor (DSP), or other processing component, processes these various signals, such as for display on computer system 300 or transmission to other devices via a communication link 318. Processor 312 may also control transmission of information, such as cookies or IP addresses, to other devices.

Components of computer system 300 also include a system memory component 314 (e.g., RAM), a static storage component 316 (e.g., ROM), and/or a disk drive 317. Computer system 300 performs specific operations by processor 312 and other components by executing one or more sequences of instructions contained in system memory component 314. Logic may be encoded in a computer readable medium, which may refer to any medium that participates in providing instructions to processor 312 for execution. Such a medium may take many forms, including but not limited to, non-volatile media, volatile media, and transmission media. In various implementations, non-volatile media includes optical or magnetic disks, volatile media includes dynamic memory, such as system memory component 314, and transmission media includes coaxial cables, copper wire, and fiber optics, including wires that comprise bus 302. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 300. In various other embodiments of the present disclosure, a plurality of computer systems 300 coupled by communication link 318 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing information about user accounts, where the information comprises a user account identifier; and
one or more hardware processors in communication with the memory, wherein the one or more hardware processors performs:
receiving, by a payment provider, a request for payment from a merchant device via a credit card or bank card network, wherein the payment provider is different than a credit card issuer or a bank card issuer;
accessing an account of a user with the payment provider associated with the request for payment;
processing the request for payment; and
notifying a merchant a result of the processing via the credit card or bank card network.

2. The system of claim 1, wherein the one or more processors further receives information about the account of the user from the merchant device.

3. The system of claim 2, wherein the information is received by reading a user card at the merchant device.

4. The system of claim 3, wherein the reading is by a card swipe.

5. The system of claim 3, wherein the reading is by an NFC communication.

6. The system of claim 1, wherein the one or more processors further receives a PIN from the user via the credit card or bank card network after the accessing.

7. The system of claim 1, wherein the merchant is not integrated with the payment provider.

8. A non-transitory machine-readable medium comprising a plurality of machine-readable instructions which when executed by one or more processors of a server are adapted to cause the server to perform a method comprising:
receiving, by a payment provider, a request for payment from a merchant device via a credit card or bank card network, wherein the payment provider is different than a credit card issuer or a bank card issuer;
accessing an account of a user associated with the request for payment;
processing the request for payment; and
notifying a merchant a result of the processing via the credit card or bank card network.

9. The non-transitory machine-readable medium of claim 8, wherein the processor receives information about the account of the user from the merchant device.

10. The non-transitory machine-readable medium of claim 9, wherein the information is received by reading a user card at the merchant device.

11. The non-transitory machine-readable medium of claim 10, wherein the reading is by a card swipe.

12. The non-transitory machine-readable medium of claim 10, wherein the reading is by an NFC communication.

13. The non-transitory machine-readable medium of claim 8, wherein the method further comprises receiving a PIN from the user via the credit card or bank card network after the accessing.

14. The non-transitory machine-readable medium of claim 8, wherein the merchant is not integrated with the payment provider.

15. A method, comprising:
receiving, electronically by a hardware processor of a payment provider, a request for payment from a merchant device via a credit card or bank card network, wherein the payment provider is different than a credit card issuer or a bank card issuer;
accessing, by the processor, an account of a user associated with the request for payment;
processing, electronically by the processor, the request for payment; and
notifying a merchant, by the processor, a result of the processing via the credit card or bank card network.

16. The method of claim 15, further comprising receiving information about the account of the user from the merchant device.

17. The method of claim 16, wherein the information is received by reading a user card at the merchant device.

18. The method of claim 17, wherein the reading is by a card swipe.

19. The method of claim 17, wherein the reading is by an NFC communication.

20. The method of claim 15, further comprising receiving a PIN from the user via the credit card or bank card network after the accessing.

21. The method of claim 15, wherein the merchant is not integrated with the payment provider.
